(19) United States
(12) Patent Application Publication
(10) Pub. No.: US 2024/0092524 A1
(43) Pub. Date: Mar. 21, 2024

(54) PRESSURE ACTUATED STICKER DISPENSER

(71) Applicant: Melissa & Doug, LLC, Wilton, CT (US)

(72) Inventors: Micah Kruzel, Yonkers, NY (US); Jeff Butler, Rye Brook, NY (US); Brian Rojas-Edge, Madison, WI (US); Graham Wilson, Denver, CO (US)

(21) Appl. No.: 18/234,980

(22) Filed: Aug. 17, 2023

Related U.S. Application Data
(60) Provisional application No. 63/406,950, filed on Sep. 15, 2022.
(60) Provisional application No. 63/527,716, filed on Jul. 19, 2023.

(51) Int. Cl. B65C 11/00; A63H 33/30

(52) U.S. Cl. CPC B65C 11/002; A63H 33/3083

(57) ABSTRACT

The present disclosure provides embodiments of a sticker dispenser including a dispenser body. The dispenser body defines an inner cavity arranged along a longitudinal axis. A pusher member is disposed within the cavity and extends along the longitudinal axis. A sticker cartridge is movable within the dispenser body along the longitudinal axis, and an outside surface of cartridge is shaped to fit into the inner cavity. A plurality of stickers are arranged in a stack and disposed within the cartridge. Each sticker includes an adhesive surface and a non-adhesive surface. A bottommost sticker is arranged at a distal end of the cartridge and a topmost sticker is arranged within the cartridge proximal of the bottommost sticker.

### REFERENCE TO RELATED APPLICATIONS

The present disclosure is based on and claims priority to U.S. Provisional Application No. 63/406,950 dated Sep. 15, 2022 entitled PRESSURE ACTUATED STICKER DISPENSER and U.S. Provisional Application No. 63/527,716 dated Jul. 19, 2023 entitled MODIFIED PRESSURE ACTUATED STICKER DISPENSER, the contents of each of which are incorporated herein by reference.

### BACKGROUND

### Field

The disclosure is related to a sticker dispenser and, more particularly, a pressure actuated sticker dispenser. In particular, the disclosure relates to a device that holds a number of stickers in a replaceable cartridge and dispenses the stickers one-at-a-time when the device is pressed against a surface.

### Description of the Related Art

Various types of devices exist for dispensing stickers. Many of these devices utilize mechanical mechanisms utilizing springs, rotating arms and gears, etc. Such systems provide multiple pinch points or other hazards and may only be suitable for use by adults.

Accordingly, a need exists for a sticker dispensing device that is safe and easy to use. In particular, the sticker dispensing device should provide minimal moving parts and pinch points and should be capable of being safely used by a child either alone or under supervision of an adult.

### SUMMARY

The present disclosure provides embodiments of sticker dispensers including a dispenser body. The dispenser body defines an inner cavity arranged along a longitudinal axis. A pusher member is disposed within the cavity and extends along the longitudinal axis. A sticker cartridge is movable within the dispenser body along the longitudinal axis, and an outside surface of cartridge is shaped to fit into the inner cavity. A plurality of stickers are arranged in a stack and disposed within the cartridge. Each sticker includes an adhesive surface and a non-adhesive surface. A bottommost sticker is arranged at a distal end of the cartridge and a topmost sticker is arranged within the cartridge proximal of the bottommost sticker.

A sticker dispenser according to another illustrative embodiment includes a dispenser body which defines an inner cavity arranged along a longitudinal axis. A pusher member is disposed within the inner cavity and extends along the longitudinal axis. A replaceable sticker cartridge is movable within the inner cavity along the longitudinal axis. The replaceable sticker cartridge includes a plurality of stickers arranged in a stack. The replaceable sticker cartridge further includes one or more ridges extending toward an inside surface of the dispenser body creating an interference fit to removably and slidably secure the cartridge within the cavity.

### BRIEF DESCRIPTION OF THE DRAWINGS

The figures depict embodiments for purposes of illustration only. One skilled in the art will readily recognize from the following detailed description that alternative embodiments of the structures illustrated herein may be employed without departing from the principles described herein, wherein:

FIG. 1A is a perspective view of a sticker dispenser with the sticker cartridge removed from the dispenser body according to an illustrative embodiment of the present disclosure;

FIG. 1B is a cross-sectional view of the sticker dispenser illustrated in FIG. 1A according to an illustrative embodiment of the present disclosure;

FIG. 1C is a perspective view of a sticker dispenser with the sticker cartridge inserted into the dispenser body according to an illustrative embodiment of the present disclosure;

FIG. 1D is a cross-sectional view of the sticker dispenser illustrated in FIG. 1C according to an illustrative embodiment of the present disclosure;

FIG. 2 is an enlarged cross-sectional view of a portion of the sticker dispenser illustrated in FIG. 1D according to an illustrative embodiment of the present disclosure;

FIG. 3 is an enlarged cross-sectional view of a portion of the sticker dispenser illustrated in FIG. 1D according to an illustrative embodiment of the present disclosure;

FIG. 4 is a bottom end perspective view of the dispenser body according to an illustrative embodiment of the present disclosure;

FIGS. 5A-5D are cross-sectional views of a portion of the sticker dispenser illustrated in FIG. 1C for describing operation of the sticker dispenser according to an illustrative embodiment of the present disclosure;

FIG. 6A is a perspective view of a sticker dispenser with the sticker cartridge removed from the dispenser body according to an illustrative embodiment of the present disclosure;

FIG. 6B is a cross-sectional view of the sticker dispenser illustrated in FIG. 6A according to an illustrative embodiment of the present disclosure;

FIG. 6C is a perspective view of a sticker dispenser with the sticker cartridge inserted into the dispenser body according to an illustrative embodiment of the present disclosure;

FIG. 6D is a cross-sectional view of the sticker dispenser illustrated in FIG. 6C according to an illustrative embodiment of the present disclosure;

FIG. 7 is a perspective view of a sticker cartridge according to an illustrative embodiment of the present disclosure;

FIG. 8 is a cross-sectional view of the sticker cartridge illustrated in FIG. 7 according to an illustrative embodiment of the present disclosure;

FIG. 9 is a bottom end perspective view of the dispenser body according to an illustrative embodiment of the present disclosure;

FIGS. 10A-10D are cross-sectional views of a portion of the sticker dispenser illustrated in FIG. 6C for describing operation of the sticker dispenser according to an illustrative embodiment of the present disclosure;

FIG. 11 is a perspective view of a sticker dispenser including a figurine according to an illustrative embodiment of the present disclosure; and

FIG. 12 is a view of a sticker for use with a sticker dispenser according to embodiments of the disclosure.

### DETAILED DESCRIPTION

The present disclosure provides embodiments of sticker dispensers for applying pressure sensitive stickers or decals to a surface. According to an illustrative embodiment, the device holds a number of stickers in a replaceable cartridge and dispenses the stickers one-at-a-time when the device is pressed against a surface. The disclosed sticker dispensing devices are safe and easy for use by a child.

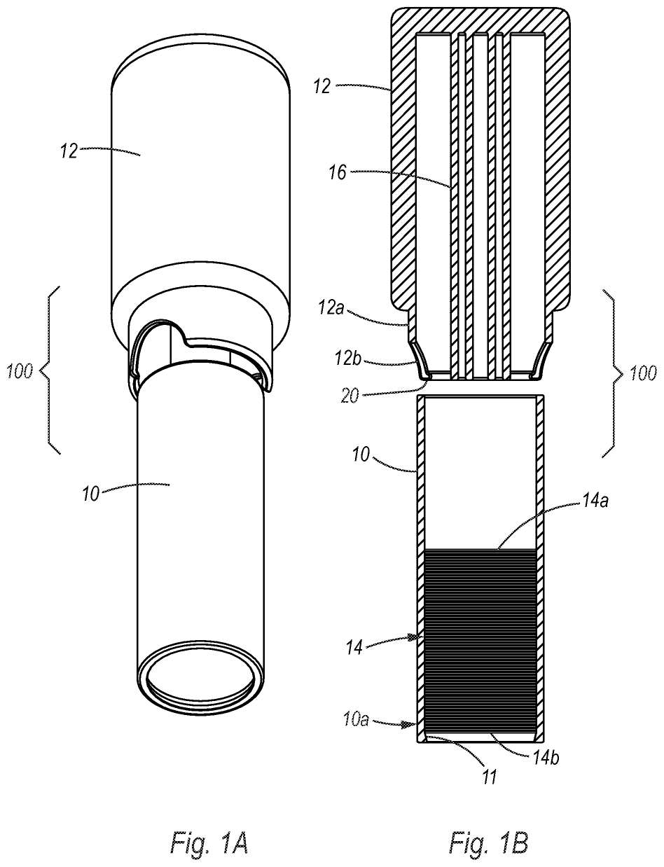

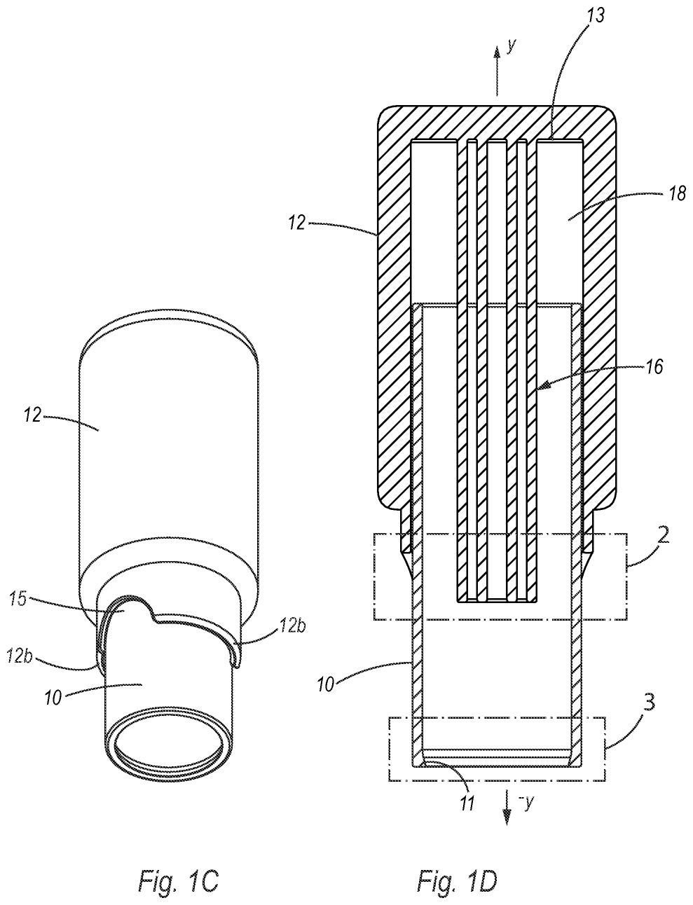

A sticker dispenser according to an illustrative embodiment of the present disclosure is shown in FIGS. 1A-5D and is referred to herein as sticker dispenser or simply dispenser 100. Sticker dispenser 100 includes a dispenser body 12 and a cartridge 10. Cartridge 10 is capable of holding a plurality of pressure sensitive adhesive stickers 14. Cartridge 10 is removable and replaceable. FIGS. 1A and 1B show cartridge 10 prior to being inserted into dispenser body 12. FIGS. 1C and 1D show cartridge 10 inserted into dispenser body 12.

According to the present illustrative embodiment, cartridge 10 is formed as a hollow tube and at least the outer portion of cartridge 10 is substantially round in cross-section. However, it is contemplated by the present disclosure that cartridge 10 may have any other suitable cross-sectional shape as desired. As depicted in FIG. 1B, a stack of stickers 14 are positioned within the distal end 10a of cartridge 10. The stack may generally include up to three-hundred stickers 14 or more. Dispenser body 12 is hollow and has a cavity 18. The cross-sectional shape of cavity 18 corresponds to the cross-sectional shape of the outer portion of cartridge 10 and, in the present embodiment, is also substantially round in cross-section. The outside diameter of cartridge 10 is slightly smaller than an inside diameter of dispenser body 12. As shown in FIG. 1D, cartridge 10 is inserted into cavity 18 inside of dispenser body 12. A pusher 16 is connected with the proximal inner end surface 13 of dispenser body 12 and extends within cavity 18 along the longitudinal axis of dispenser body 12 for at least a portion of the length of dispenser body 12. Pusher 16 may be mechanically joined to proximal inner end surface 13 of dispenser body 12 by heat or chemical weld, glue or any other suitable type of mechanical connection. Alternatively, pusher 16 may be formed in situ with the proximal inner end surface 13 during manufacture of dispenser body 12. As shown in the end view of dispenser body 12 depicted in FIG. 4, pusher 16 extends from proximal inner end surface 13 of dispenser body 12 and includes a pair of concentric circular portions including inner portion 16b and outer portion 16a. When cartridge 10 is inserted into cavity 18 of dispenser body 12, the distal end of pusher 16 extends into the cartridge 10 and contacts the topmost sticker 14a as will be described later below. Bottommost sticker 14b is thus positioned across the open distal end 10a of cartridge 10.

Dispenser body 12 and/or cartridge 10 may be formed from plastic, metal, wood, or cardboard. According to one embodiment of the present disclosure, dispenser body 12 and cartridge 10 are formed from a molded polymer. According to the present illustrative embodiment, dispenser body 12 and cartridge 10 are formed from Polypropylene. According to another embodiment, dispenser body 12 and/or cartridge 10 are formed from ABS plastic. Cartridge 10 may have about a 1.5 mm wall thickness and an inner diameter of about 22.5 mm. Dispenser body 12 may generally be thicker for most of its length and may have a thinner wall at its distal end 12b which may be about 1.5 mm in thickness.

According to an embodiment of the present disclosure, a number of cartridges 10 may be provided to a user, each containing the same or different stickers along with a single dispenser body 12. Cartridge 10 may be removed from the dispenser body 12 when all of the stickers 14 have been dispensed or when the user wants to change stickers. A user can easily change cartridges 10 to provide different kinds of stickers for different pieces of artwork simply by pulling cartridge 10 from dispenser body 12 and inserting a different cartridge 10 having different stickers. The stickers in a cartridge 10 may be different but based on the same specific theme (sea life, birds, vehicles, mythical creatures, etc.). Each sticker 14 in a cartridge 10 may be the same or may be randomly different. Stickers 14 may be stacked in a particular order if desired. For example, the stickers 14 may be stacked alternately with stickers having “X”s and “O”s, allowing children to interact while playing games of tic-tac-toe.

Stickers 14 have an adhesive side facing in the distal direction and a non-adhesive side facing in the proximal direction. As a result, the exposed surface of bottommost sticker 14b is an adhesive surface (e.g., see FIG. 1B). Pusher 16 is in contact with the non-adhesive surface of topmost sticker 14a. As stickers 14 are dispensed, as will be explained below, cartridge 10 moves in the proximal direction further into cavity 18 of dispenser body 12. Pusher 16 remains in contact with the topmost sticker. According to one embodiment, cartridge 10 may be provided with a removable seal (not shown) across its distal end to protect the adhesive surface 14b of the bottom most sticker. The seal is removed prior to use. Stickers are formed from a flexible material such as paper or a polymer. According to one embodiment, stickers 14 are formed from vinyl.

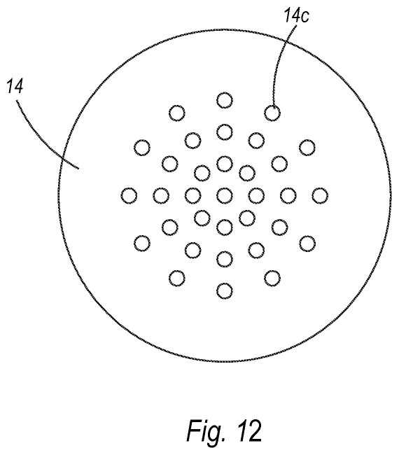

Adhesive applied to stickers 14 may be applied to cover the entire distal-facing surface of the sticker. According to another embodiment, adhesive is applied to a portion of the distal-facing surface of the sticker. According to a further embodiment, adhesive is applied in concentric rings on the sticker with spaces between the rings substantially free of adhesive. According to another embodiment, adhesive is applied in a pattern of dots. FIG. 12 shows dots of adhesive 14c applied to a sticker 14 according to one embodiment of the disclosure.

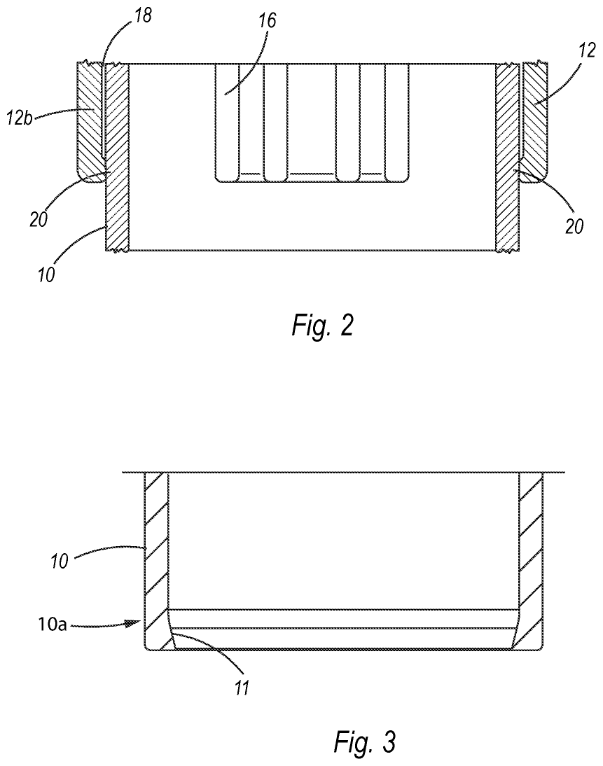

FIG. 2 shows a detailed view of a cross-section of a portion of cartridge 10 and dispenser 12 taken from FIG. 1D. At the distal end 12b of dispenser body 12, one or more ridges 20 are provided extending inward toward the inside of cavity 18. The size of the ridges 20 is selected so that an interference fit with the outside surface of cartridge 10 is achieved. Portions of dispenser body 12 supporting ridges 20 may flex outward with a predetermined elasticity to create a desired amount of friction with the outside surface of the cartridge 10. According to an illustrative embodiment of the present disclosure, the distal end of dispenser body 12 may include one or more cut-out portions or finger openings 15 (e.g., see FIG. 1C). According to the present embodiment two openings 15 are provided 180 degrees apart in the distal end portion 12b of dispenser body 12. In addition to providing a convenient access point for grasping cartridge 10 when removing it from dispenser body 12, the openings separate ridges 20, allowing those portions of dispenser body 12 having the ridges 20 to flex away from the longitudinal axis, making it even easier to insert a cartridge 10 into dispenser body 12 while still providing sufficient interference fit. The interference fit is selected to securely hold the cartridge 10 in dispenser body 12 and to keep pusher 16 in contact with the topmost sticker 14a, while also allowing the cartridge to slide easily into cavity 18 as stickers 14 are dispensed and to allow cartridge to be easily pulled from dispenser body 12 when a new cartridge 10 is to be inserted. According to one embodiment, the size and shape of ridges 20 and the elasticity of flexible portions may be selected to accommodate variations in the outer diameter of cartridge 10 which may occur, for example, due to manufacturing tolerances. While two ridges 20 are shown in the present embodiment, the disclosure is not limited to two ridges. For example, one, two or three or more ridges 20 may be provided. Also, instead of or in addition to ridges 20, one or more annular rings may be provided along the interior surface of dispenser body 12 extending into cavity 18 and/or on the exterior surface of cartridge 10 to form an interference fit with cartridge 10. Alternatively or in addition to ridges 20 and/or annular rings, a high friction surface, such as a silicon rubber surface may be provided on the outside surface of cartridge 10 and/or the inside surface of dispenser body 12 to create a secure but slidable engagement between cartridge 10 and dispenser body 12.

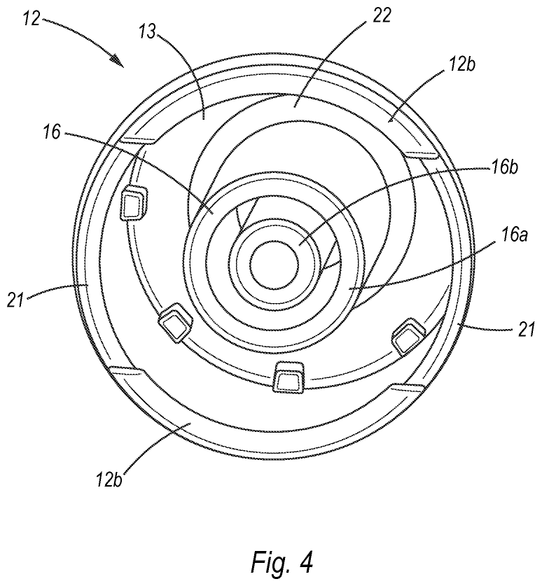

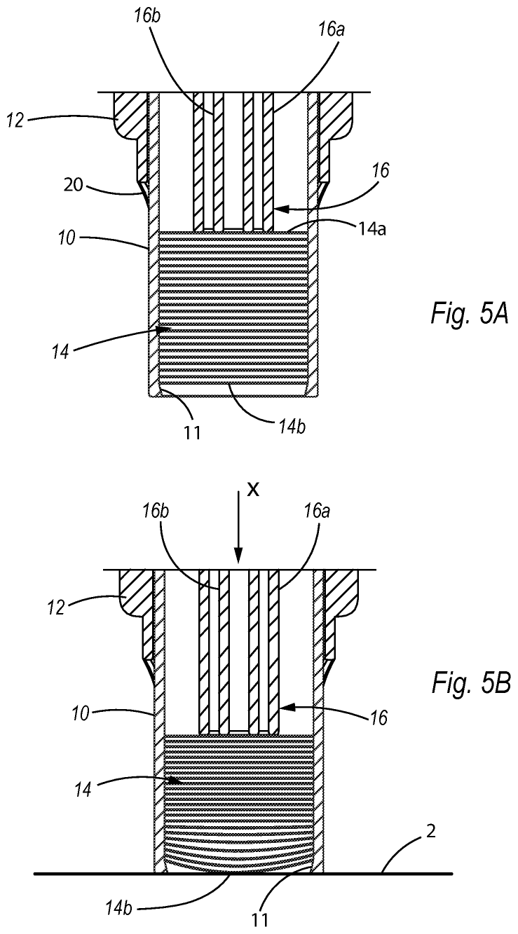

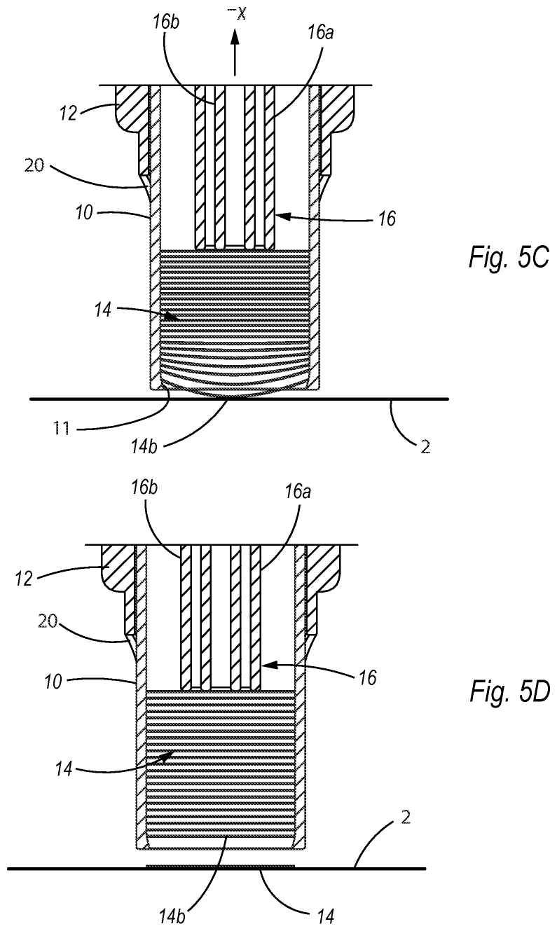

FIG. 3 shows a detailed cross-sectional view of the distal end portion 10a of cartridge 10 taken from FIG. 1D. The wall forming the inside surface of the distal end portion 10a of cartridge 10 is tapered inward to provide a reduced radius portion 11 around at least a portion of opening at distal end portion 10a. A diameter of the reduced radius portion 11 is smaller than a diameter of the stickers 14. As depicted in FIGS. 5A-5D, stickers 14 are positioned proximal of the reduced radius portion 11 inside cartridge 10 with the edges of the adhesive surface of the bottommost sticker 14b adjacent reduced radius portion 11. According to one embodiment, the reduced radius portion has a radius about 0.5 mm less than the remainder of the inside radius of the cartridge 10 to provide an opening where stickers having a diameter of about 20 mm may be dispensed.

In operation, a number of stickers 14 are arranged inside cartridge 10 proximal of reduced diameter portion 11 as shown in FIG. 5A. According to an embodiment, up to 300 stickers 14 or more may be provided in cartridge 10. As noted above, the stickers 14 may have a variety of colors, patterns, or designs printed on surface 14a and an adhesive surface on the opposite surface. A proximal end of cartridge 10 is inserted into cavity 18 of dispenser body 12 so that the top, non-adhesive surface of topmost sticker 14a is in contact with pusher 16. As described above with respect to FIG. 2, engagement between ridges 20 extending inward on dispenser body 12 and the outside surface of cartridge 10 secures the cartridge 10 in the dispenser body 12. To dispense a sticker 14, the user grasps dispenser body 12 and presses the distal end 10a of cartridge 10 in direction “X” against a surface, such as a piece of artwork 2, where a sticker 14 is to be placed as depicted in FIG. 5B. Contact between the adhesive surface of the bottommost sticker 14b and the surface of the artwork 2 causes the central portion of the adhesive surface of sticker 14b to adhere to the artwork. Reduced radius portion 11 at the distal end of cartridge 10 holds the edges of the sticker 14b away from the surface 2 so that sticker 14b is flexed slightly. The user then lifts the dispenser body 12 and cartridge 10 away from the artwork 2 in direction “−X” as depicted in FIG. 5C. Adhesion between the central portion of sticker 14b and artwork 2 pulls the sticker 14b away from the adhesive surface of the adjacent sticker 14 in dispenser 10 and holds the bottommost sticker 14b to the artwork 2. Because the edges of sticker 14b are not yet in contact with the surface of the artwork 2, sticker 14b flexes, causing the edges of the sticker 14b to move axially away from the inside surface of cartridge 10 and allowing the edges of the sticker 14b to fit through reduced radius portion 11 and adhere to artwork 2 as depicted in FIG. 5D. The adjacent sticker 14 in the stack remains in cartridge 10 and becomes the next bottommost sticker 14b.

When the user is ready to dispense another sticker 14, the process is repeated. That is, the user again presses the distal end of cartridge 10 in direction “X” against the artwork 2. Pressure on the dispenser body 12 in the proximal direction pushes the cartridge 10 into cavity 18, overcoming friction caused by ridges 20 in contact with the outside surface of the cartridge 10 so that pusher 16 is again pressed against the non-adhesive surface 14a of topmost sticker 14a. The user presses dispenser body 12 toward the artwork, pressing the adhesive surface of the bottommost sticker 14b against the artwork 2. When the dispenser 12 is pulled away, this sticker 14b remains adhered to the artwork 2.

The process is repeated, with cartridge 10 moving proximally into dispenser body 12 as each sticker 14 is dispensed. When all of the stickers 14 are dispensed or the user desires to change stickers, the cartridge 10 is removed by pulling it in the direction “−Y” and/or by pulling dispenser body 12 in direction “Y” as shown in FIG. 1D. A new cartridge 10 with a new set of stickers 14 may then be inserted into cavity 18 of dispenser body 12.

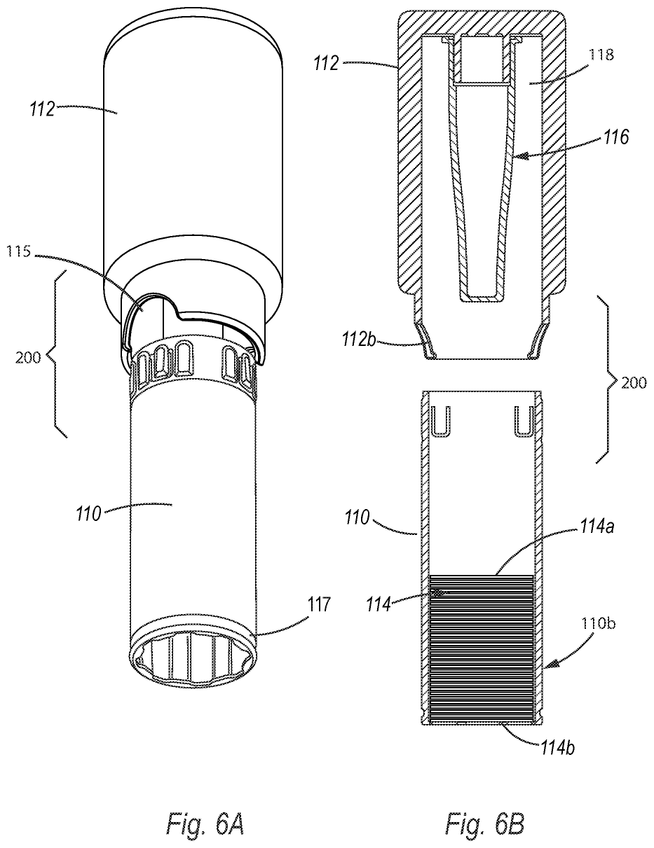

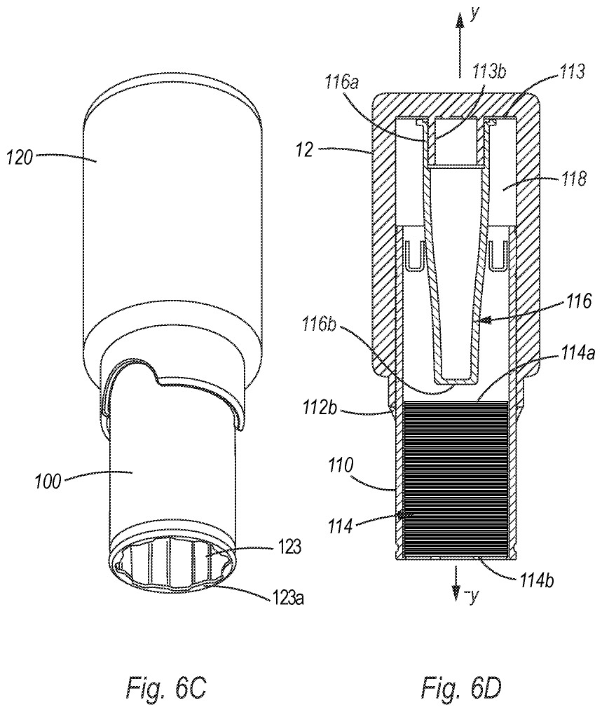

A sticker dispenser according to another illustrative embodiment of the present disclosure is shown in FIGS. 6A-10D and is referred to herein as sticker dispenser or simply dispenser 200. Sticker dispenser 200 includes a dispenser body 112 and a removable and replaceable sticker holding cartridge 110. Cartridge 110 is capable of holding a plurality of pressure sensitive adhesive stickers 114. FIGS. 6A and 6B show cartridge 110 prior to being inserted into dispenser body 112. FIGS. 6C and 6D show cartridge 110 inserted into dispenser body 112.

According to the present illustrative embodiment, cartridge 110 is formed as a hollow tube and at least the outer portion of cartridge 110 is substantially round in cross-section. However, it is contemplated by the present disclosure that cartridge 110 may have any other suitable cross-sectional shape as desired. As depicted in FIG. 6B, a stack of stickers 114 are positioned within the distal end 110b of cartridge 110. The stack may include up to three hundred stickers 114 or more. Dispenser body 112 is hollow and has an inside cavity 118. The cross-sectional shape of inside cavity 118 corresponds to the cross-sectional shape of the outer portion of cartridge 110 and, in the present embodiment, is also substantially round in cross-section. The outside diameter of cartridge 110 is slightly smaller than an inside diameter of dispenser body 112. As shown in FIG. 6D, cartridge 110 is inserted into cavity 118 inside of dispenser body 112. A pusher 116 is connected at the proximal inner end surface 113 of dispenser body 112 and extends within cavity 118 along the longitudinal axis for at least a portion of the length of dispenser body 112. According to the present illustrative embodiment, pusher 116 is a tapered hollow body having a substantially round cross-sectional shape, although other cross-sectional shapes are contemplated. Pusher 116 has an open proximal end 116a and a closed flat distal push end 116b. Proximal inner end surface 113 of dispenser body 112 may include a stanchion or post 113b which extends into cavity 118. Post 113b may be formed in situ during manufacture of dispenser body 112. Open proximal end 116a of pusher 116 may be mechanically joined to proximal inner end surface 113 and/or post 113b of dispenser body 112 by heat or chemical weld, glue or any other suitable type of mechanical connection. Alternatively, pusher 116 may be formed in situ with the proximal inner end surface 113 during manufacture of dispenser body 112. When cartridge 110 is inserted into cavity 118 of dispenser body 112, the distal end 116b of pusher 116 extends into the cartridge 110 and contacts the topmost sticker 114a. Bottommost sticker 114b is positioned across the open distal end 110b of cartridge 110.

Dispenser body 112 and/or cartridge 110 may be formed from plastic, metal, wood, or cardboard. According to the present illustrative embodiment, dispenser body 112 and cartridge 110 are formed from a molded polymer. According to a preferred embodiment of the present disclosure, dispenser body 112 and cartridge 110 may be formed from Polypropylene. Cartridge 110 may have about a 1.5 mm wall thickness and an inner diameter of about 22.5 mm. Dispenser body 112 may generally be thicker for most of its length and may have a thinner wall at its distal end 112b which may be about 1.5 mm in thickness.

According to an illustrative embodiment of the present disclosure, a number of cartridges 110 may be provided to a user, each containing the same or different stickers 114 along with a single dispenser body 112. Cartridge 110 may be removed from the dispenser body 112 when all of the stickers 114 have been dispensed or the user desires to change stickers. A user can easily change cartridges 110 to provide different kinds of stickers 114 for different pieces of artwork simply by pulling cartridge 110 from dispenser body 112 and inserting a different cartridge 110 having different stickers 114. The stickers 114 in a cartridge 110 may be different but based on the same specific theme (sea life, birds, vehicles, mythical creatures, etc.). The stickers 114 may have a variety of colors, patterns, or designs printed on them. Each sticker 114 in a cartridge 110 may be the same or may be randomly different. The stickers 114 may be stacked in a particular order if desired. For example, the stickers 114 may be stacked alternately with stickers having “X”s and “O”s, allowing children to interact while playing games of tic-tac-toe.

Stickers 114 have an adhesive side facing in the distal direction and a non-adhesive side facing in the proximal direction. As a result, the exposed surface of bottommost sticker 114b is an adhesive surface (e.g., see FIG. 6D). Pusher 116 is in contact with the non-adhesive surface of topmost sticker 114a. As stickers 114 are dispensed, as will be explained below, cartridge 110 moves in the proximal direction further into cavity 118 of dispenser body 112. Pusher 116 remains in contact with the topmost sticker 114a.

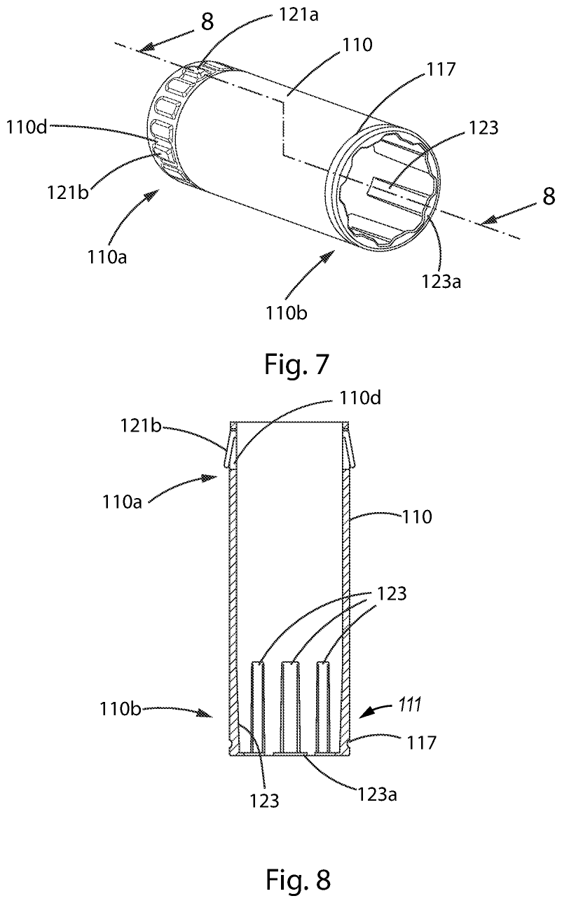

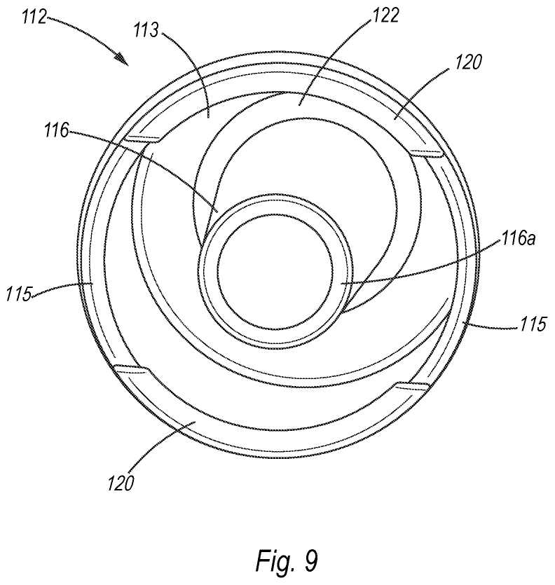

As shown in FIGS. 7 and 8, at the proximal end portion 110a of cartridge 110, a plurality of evenly spaced ridges 121a are provided on the outside surface of cartridge 110. In addition, a plurality of flexible tabs 121b extend outwardly from within openings 110d provided in cartridge 110. The flexible tabs 121b may be spaced evenly around the circumference of cartridge 110. For example, according to the present illustrative embodiment, 4 flexible tabs 121b are spaced 90 degrees apart around the circumference of cartridge 110. Flexible tabs 121b normally extend outward with a predetermined elasticity to create a desired amount of friction with the inside surface of the dispenser body 112 and flex inward when cartridge 110 is inserted into dispenser body 112. According to the present illustrative embodiment, the size and shape of ridges 121a and the elasticity of flexible tabs 121b accommodate for variations in the outer diameter of cartridge 110 and the inner diameter of dispenser body 112, for example, due to manufacturing tolerances. The size of the ridges 121a and flexible tabs 121b are selected to provide an interference fit with the inside surface of dispenser body 112. The interference fit holds cartridge 110 in dispenser body 112. The fit is selected to securely hold the cartridge 110 in dispenser body 112 and to keep pusher 116 in contact with the topmost sticker 114a, while also allowing the cartridge 110 to slide easily into cavity 118 as stickers 114 are dispensed and to be easily pulled from the dispenser body 112 when a replacement cartridge 110 is to be inserted. If further interference fit is desired between the dispenser body 112 and cartridge 110, the distal end portion 112b may include ridges 120 (as shown in FIG. 9) similar to ridges 20 described above with respect to the embodiment depicted in FIGS. 1A-5D. Similarly, portions of dispenser body 112 supporting ridges 120 may flex outward with a predetermined elasticity to create a desired amount of friction with the outside surface of the cartridge 110 as also described above.

A plurality of longitudinal tapered ribs 123 are provided along the inside distal end portion 110b of cartridge 110. Each tapered rib 123 may include a tab 123a which extends inward at the opening at the distal end 110b of cartridge 110 as shown in FIGS. 7 and 8. The longitudinal tapered ribs 123 and tabs 123a form a reduced radius portion 111 at the distal end 110b of cartridge 110. A diameter of the reduced radius portion 111 is smaller than a diameter of the stickers 114. Stickers 114 are positioned in the reduced radius portion 111 inside cartridge 110 with the edges of the adhesive surface of the bottommost sticker 114b adjacent reduced radius portion 111. According to one embodiment, the reduced radius portion has a radius about 0.5 mm less than the remainder of the inside radius of the cartridge 110 to provide an opening where stickers are dispensed of about 20 mm. Stickers 114 move along cartridge in the distal direction as they are being dispensed and flex as they slid along tapered ribs 123. The bottom-most sticker 114b is held in cartridge 110 in an outwardly flexed configuration by tabs123a and is ready to be dispensed when pressed against a surface. According to a further embodiment, reduced radius portion 111 has no tabs 123a. Instead, stickers 114 are dispensed when the edges of the bottom-most sticker 114b passes the distal end of ribs 123. According to another embodiment, tabs 123a are disposed at the distal end reduced radius portion 111 in the spaces between ribs 123 so that ribs 123 and tabs 123a alternate about the inner circumference of cartridge 110.

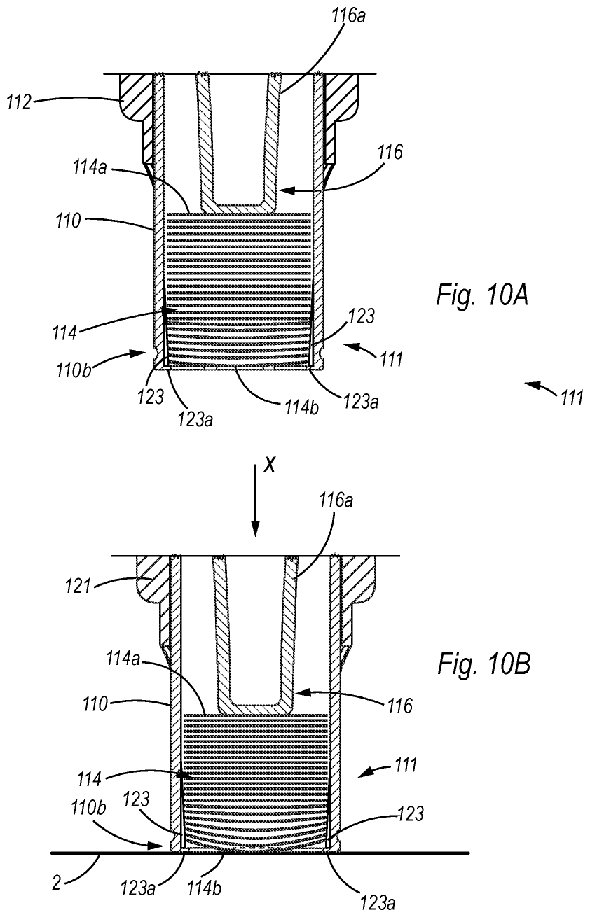

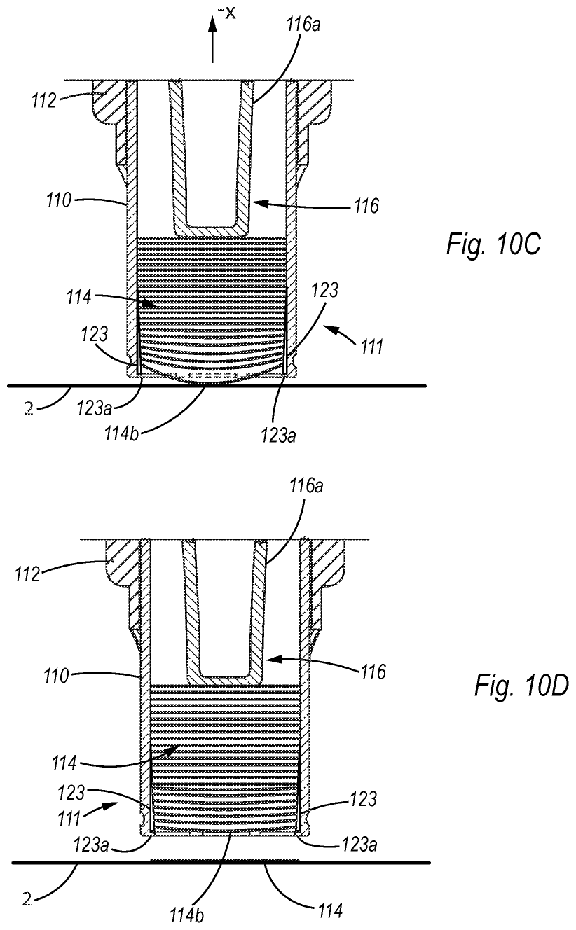

In operation, a number of stickers 114 are arranged inside cartridge 110 proximal of reduced radius portion 111 as shown in FIGS. 6D and 10A. According to an embodiment of the present disclosure, up to three hundred stickers 114 or more may be provided in cartridge 110. The proximal end 110a of cartridge 110 is inserted into cavity 118 of dispenser body 112 so that the top, non-adhesive surface 114a of topmost sticker 114 is in contact with the distal end surface 116b of pusher 116. Referring to FIGS. 10A-10D, to dispense a sticker 114, the user grasps dispenser body 112 and presses the distal end 110b of cartridge 110 in direction “X” against a surface, such as a piece of artwork 2, where a sticker is to be placed as depicted in FIG. 10B. Contact between the adhesive surface of the bottommost sticker 114b and the surface of the artwork 2 causes the central portion of the adhesive surface of sticker 114b to adhere to the artwork. The reduced radius portion 111 comprised of ribs 123 and/or tabs 123a at the distal end of cartridge 110 holds the edges of the sticker 114b away from the surface 2 so that sticker 114b is flexed slightly. The user then lifts the dispenser 112 and cartridge 110 away from the artwork 2 in direction “−X” as depicted in FIG. 10C. Adhesion between the central portion of sticker 114b and the artwork 2 pulls the sticker 114b away from the adhesive surface of the adjacent sticker in cartridge 110 and holds sticker 114b to the artwork 2. Because the edges of sticker 114b are not yet in contact with the surface of the artwork 2, sticker 114b flexes, causing the edges of the sticker to move axially away from the inside surface of cartridge 110 and allowing the edges of the sticker to fit through reduced radius portion 111. The adjacent sticker (proximal of sticker 114b) remains in cartridge 110 and becomes the next bottommost sticker 114b (e.g., see FIG. 10D).

When the user is ready to dispense another sticker 114, the process is repeated. That is, the user again presses the distal end 110b of cartridge 110 in direction “X” against the artwork 2. Pressure on the dispenser body 112 in the proximal direction pushes the cartridge 110 into cavity 118, overcoming friction caused by ridges 121a and flexible tabs 121b in contact with the inside surface of the dispenser body 112 so that pusher 116 is pressed against the non-adhesive surface of topmost sticker 114a. The user presses dispenser body 112 toward the artwork 2, pressing the adhesive surface of the bottommost sticker against the artwork 2. When the dispenser 200 is pulled away, the sticker remains adhered to the artwork 2.

The process is repeated, with cartridge 110 moving proximally into dispenser 112 as each sticker 114 is dispensed. When all of the stickers 114 are dispensed or the user desires to change stickers, the cartridge 110 is removed by pulling it in the distal direction (e.g., direction “−Y”) and/or by pulling dispenser 112 in direction “Y” as shown in FIG. 6D. A new cartridge 110 with a new set of stickers 114 is then inserted into cavity 118 of dispenser 112. One or more finger openings 115 may be provided along distal end portion 115 of dispenser body 112. According to the present illustrative embodiment, two finger openings 115 are provided 180 degrees apart allowing the user easy access to cartridge 110 when removing it from dispenser body 112. Groove 117 may also be provided around the outer edge of distal end 110b of cartridge 110 to provide a finger grip allowing the cartridge 110 to be easily gripped and pulled from dispenser body 112.

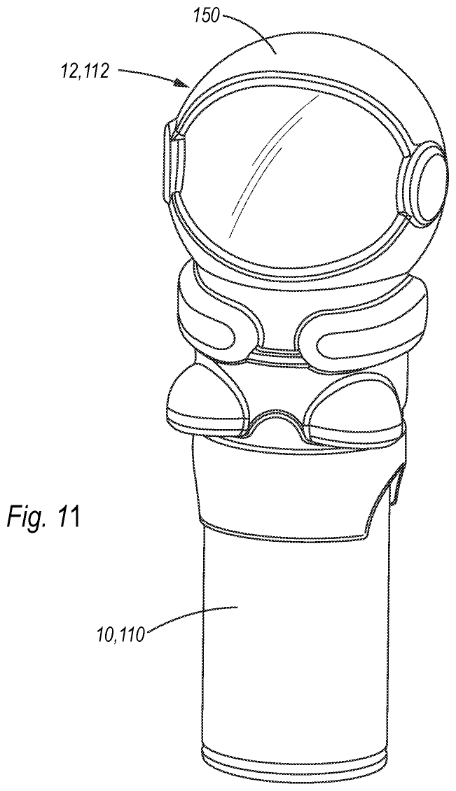

According to embodiments of the present disclosure, dispenser bodies 12, 112 may include a figurine such as an astronaut figurine 150 or other sculpted shape, as shown in FIG. 11. The figurine 150 or other sculpted shape may be formed separate from the dispenser body 12 or 112 and then attached to dispenser body 12 or 112. Alternatively, figurine 150 may be formed in situ during formation of dispenser body 12 or 112. Figurine 150 may be selected to correspond to images printed on stickers 14, 114, which might, for example, be printed with images of rocket ships, stars, planets, and the like to correspond with the astronaut. According to one embodiment, figurine 150 is formed from a different material than dispenser body 12 and over-molded to dispenser body 12. According to a further embodiment, figurine 150 is formed from an elastomer with a hardness that is less than the hardness of dispenser body 12 to provide cushioning to the user's hand when force is applied to dispense a sticker.

Certain terminology may be used in the present disclosure for ease of description and understanding. Examples include the following terminology or variations thereof: top, bottom, up, upward, upper inner, outer, outward, down, downward, upper, lower, vertical, horizontal, etc. These terms refer to directions in the drawings to which reference is being made and not necessarily to any actual configuration of the structure or structures in use and, as such, are not necessarily meant to be limiting.

As shown throughout the drawings, like reference numerals designate like or similar corresponding parts. While illustrative embodiments of the present disclosure have been described and illustrated above, it should be understood that these are exemplary of the disclosure and are not to be considered as limiting. Various portions of the described embodiments may be mixed and matched depending on a particular application. Additions, deletions, substitutions, and other modifications can be made without departing from the spirit or scope of the present disclosure. Accordingly, the present disclosure is not to be considered as limited by the foregoing description.

We claim:

1. A sticker dispenser comprising:
a dispenser body, wherein the dispenser body defines an inner cavity arranged along a longitudinal axis;
a pusher member disposed within the cavity and extending along the longitudinal axis;
a sticker cartridge movable within the dispenser body along the longitudinal axis, wherein an outside surface of cartridge is shaped to fit into the inner cavity; and
a plurality of stickers arranged in a stack and disposed within the cartridge, wherein each sticker comprises an adhesive surface and a non-adhesive surface, wherein a bottommost sticker is arranged at a distal end of the cartridge and a topmost sticker is arranged within the cartridge proximal of the bottommost sticker.

2. The sticker dispenser of claim 1, wherein the dispenser body further comprises one or more ridges disposed on an inner surface of the cavity, wherein, when the cartridge is inserted into the cavity, the ridges engage with an outside surface of the cartridge to create an interference fit to removably and slidably secure the cartridge within the cavity.

3. The sticker dispenser of claim 1, wherein the cartridge further comprises a reduced radius portion at a distal end of the cartridge along an inner surface of the cartridge, wherein the reduced radius portion comprises one or more tabs extending inwardly from the distal end of the cartridge, wherein the plurality of stickers are arranged proximal of the one or more tabs, and wherein a diameter of the reduced radius portion is smaller than a diameter of each of the plurality of stickers.

4. The sticker dispenser of claim 3, wherein the reduced radius portion further comprises one or more tapered ribs extending distally from respective ones of the one or more tabs.

5. The sticker dispenser of claim 1, wherein when the cartridge is inserted into the cavity, the pusher extends into the cartridge and contacts a topmost sticker of the plurality of stickers.

6. The sticker dispenser of claim 2, further comprising a flexible portion supporting the one or more ridges, wherein, when the cartridge is inserted into the cavity, the flexible portions flex outward from the cavity, and wherein an elasticity of the flexible portions is selected to provide a secure and slidable engagement with the cartridge.

7. The sticker dispenser of claim 1, wherein the dispenser body further comprises a decorative outer surface.

8. The sticker dispenser of claim 6, wherein the decorative surface comprises a sculpted shape.

9. A sticker dispenser comprising:
a dispenser body, wherein the dispenser body defines an inner cavity arranged along a longitudinal axis;
a pusher member disposed within the inner cavity and extending along the longitudinal axis; and
a replaceable sticker cartridge movable within the inner cavity along the longitudinal axis, the replaceable sticker cartridge comprising a plurality of stickers arranged in a stack, the replaceable sticker cartridge further comprising one or more ridges extending toward an inside surface of the dispenser body creating an interference fit to removably and slidably secure the cartridge within the cavity.

10. The sticker dispenser of claim 9, wherein the one or more ridges are fixed along an outer surface of the replaceable sticker cartridge.

11. The sticker dispenser of claim 9, wherein the one or more ridges comprise flexible ridges attached to the replaceable sticker cartridge and extending toward the inside surface of the dispenser body.

12. The sticker dispenser of claim 9, wherein the replaceable sticker cartridge further comprises a reduced radius distal end portion.

13. The sticker dispenser of claim 12, wherein the reduced radius portion comprises one or more tabs extending inward of the replaceable sicker cartridge.

14. The sticker dispenser of claim 12, wherein the reduced radius portion comprises one or more tapered ribs.

15. The sticker dispenser of claim 12, wherein the plurality of stickers are arranged proximal of the reduced radius portion, and wherein a diameter of the reduced radius portion is smaller than a diameter of each of the plurality of stickers.

16. The sticker dispenser of claim 9, wherein when the pusher extends into the cartridge and contacts a topmost sticker of the plurality of stickers.

17. The sticker dispenser of claim 9, further comprising a flexible portion supporting the one or more ridges, wherein, when the cartridge is inserted into the cavity, the flexible portions flex outward from the cavity, and wherein an elasticity of the flexible portions is selected to provide a secure and slidable engagement with the cartridge.

18. The sticker dispenser of claim 8, wherein the dispenser body further comprises a decorative outer surface.

19. The sticker dispenser of claim 15, wherein the decorative surface comprises a sculpted shape.
